(19) United States
(12) Patent Application Publication
(10) Pub. No.: US 2007/0274396 A1
(43) Pub. Date: Nov. 29, 2007

(54) Complexity adaptive skip mode estimation for video encoding

(76) Inventors: Ximin Zhang, San Jose, CA (US); Hung-Ju Lee, Pleasanton, CA (US)

Correspondence Address: O'BANION & RITCHEY LLP/ SONY ELECTRONICS, INC., 400 CAPITOL MALL, SUITE 1550, SACRAMENTO, CA, 95814, US

(21) Appl. No.: 11/441,975

(22) Filed: May 26, 2006

(51) Int. Cl. H04N 11/04; H04N 7/12

(52) U.S. Cl. 375/240.24; 375/240.26

(57) ABSTRACT

In a system and method for coding moving pictures, the cost of skip mode is estimated to determine the best coding mode. Skip mode selection within the framework of the AVC standard is improved by complexity based threshold determination, penalty modulation level adjustment and bias modulation level adjustment for the encoding mode selection.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C. F. R. §1.14.

### BACKGROUND OF THE INVENTION

1. Field of the Invention

This invention relates to a method and system for coding moving pictures, and more particularly to a method and apparatus for estimating the cost of skip mode to determine the best mode for coding Inter pictures.

2. Description of Related Art

Since the introduction of MPEG video coding standards, mode decision has been investigated by many researchers. The state of the art approaches can be divided into two categories: iterative multi-pass encoding/decoding based real R/D optimization methods and simple Lagrangian multiplier based R/D optimization methods. The iterative multi-pass methods can obtain a near optimal R/D result with huge complexity. It is only useful as a benchmark. The simple Lagrangian multiplier based R/D optimization method is more widely used. Although there are many variations in the existing simple Lagrangian multiplier based R/D optimization methods, all of them adopt a similar strategy to estimate the skip mode cost, which is sum of absolute differences (SAD)/sum of absolute transformed differences (SATD) with a fixed deduction related to the quantization parameter (QP) used in each macroblock. In this way, skip mode is always favored for mode selection.

The emerging MPEG4/AVC video encoding standard, also known as H.264, has been developed jointly by the Motion Picture Experts Group (MPEG) and the International Telecommunication Union (ITU) with the goal to provide higher compression of moving pictures than state-of-the-art video encoding systems that are compliant with existing MPEG standards. Target applications of AVC (Advanced Video Coding) include, but are not limited to, video conferencing, digital storage media, television broadcasting, internet streaming and communication.

In most digital video encoding systems, each video frame of a video sequence is divided into blocks of pixels (macroblocks). In the AVC standard, the macroblock can be further divided into smaller partitions. The encoding mode selection problem is actually selecting the best of all possible encoding modes to encode each macroblock in the video frame. The encoding mode selection problem may be solved by the video encoder in a number of different ways. One possible method of solving the encoding mode selection problem is to employ rate-distortion (R/D) optimization.

There are numerous different encoding modes that may be selected to encode each macroblock within the framework of the AVC video encoding standard. They include skip mode, 16×16 inter mode, 16×8 mode, 8×16 mode, 8×8 mode, 8×4 mode, 4×8 mode, 4×4 mode, intra 16×16 mode and intra 4×4 mode in P frames. In skip mode, no motion information and DCT (discrete or direct cosine transform) residue is transmitted to the decoder. Instead, a predictive system is used to generate motion information. The decoder directly copies the macroblock of the reference picture based on the predicted motion vector. Therefore, the skip mode can provide many bit rate savings compared to other modes. Under a certain rate budget, the suitable selection of skip mode can improve the overall R/D performance.

Similar to other video encoding standards (in their main body or annexes), the near optimal encoding mode decision can be obtained by using a true rate-distortion (R/D) based strategy. This strategy needs multi-pass encoding and the complexity is too high for most of the applications. Therefore, SAD or SATD based R/D estimation methods are widely used in reality. However, our investigations have demonstrated that the state of the art skip mode selection method does not yield satisfactory results, especially for low complexity and low bit rate coding.

Accordingly, the primary focus of the present invention is on encoding mode selection within the framework of the AVC standard. It is desirable to improve the skip mode selection in P pictures within the framework of the AVC standard.

### BRIEF SUMMARY OF THE INVENTION

The invention is directed to encoding mode selection within the framework of the AVC standard. The invention is a method and apparatus for improving the skip mode selection in P pictures within the framework of the AVC standard. Skip mode improvements are achieved by complexity based threshold determination, penalty modulation level adjustment and bias modulation level adjustment for the encoding mode selection.

Experimental results have demonstrated the superior subjective and objective quality of the present invention on various video sequences. When fixed quantization is used, the compressing bit rate obtained by using the present invention is reduced as compared to the compressing bit rate obtained using the reference encoder. When rate control is used, the objective quality (PSNR) from the present invention is increased as compared to the result obtained using the reference encoder. This improvement is obtained without any complexity increase. Although the present invention makes use of the AVC framework, the encoding method of the present invention is applicable in any video encoding system that employs the block based encoding design.

An aspect of the invention is a method for estimating skip mode cost in the coding of a macroblock in a video frame, by determining an initial skip mode cost; and modulating the initial skip mode cost based on complexity or expected distortion of the skip mode. The initial skip mode cost is modulated by determining a threshold; comparing the initial skip mode cost to the threshold; adding a penalty to the initial skip mode cost if the initial skip mode cost is greater than the threshold; and deducting a bias from the initial skip mode cost if the initial skip mode cost is less than the threshold.

The method may also include adjusting the threshold, and modulating the level of the penalty or bias. The initial skip mode cost may be determined by obtaining a predicted motion vector from neighbor macroblocks and calculating the SAD or SATD between a current macroblock and a predicted macroblock. The threshold may be determined by deriving a quantization scale and the threshold may be estimated from the quantization scale.

Another aspect of the invention is a method for selecting a coding mode for coding a macroblock in a video frame, by estimating skip mode cost by the disclosed method and comparing the estimated skip mode cost to an inter mode cost and an intra mode cost to select the lowest cost. The invention includes a method for coding a video frame, by dividing the video frame into macroblocks; and selecting a coding mode for each macroblock by the disclosed method; and coding each macroblock using the selected mode.

The invention also includes a machine readable medium containing instructions, which when executed by a machine, cause the machine to perform the disclosed methods.

Also an aspect of the invention is apparatus for estimating skip mode cost in the coding of a macroblock in a video frame, including a motion vector prediction unit; a difference calculator to provide an initial skip mode cost; a quantization determination unit; a threshold estimator to provide a threshold; a comparator to compare the initial skip mode cost to the threshold; a penalty modulation unit to add a penalty if the initial skip mode cost is greater than the threshold; a bias modulation unit to deduct a bias if the initial skip mode cost is less than the threshold; and a skip mode cost modulation unit to provide a final skip mode cost. The invention includes apparatus for estimating skip mode cost in the coding of a macroblock in a video frame, and apparatus for coding a video frame, each comprising a processor containing the disclosed machine readable medium. Apparatus for estimating skip mode cost in the coding of a macroblock in a video frame also includes means for determining an initial skip mode cost; and means modulating the initial skip mode cost based on complexity or expected distortion of the skip mode.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a flowchart of the basic steps of an embodiment of a video coding method according to the present invention, including encoding mode selection.

FIG. 2 is a block diagram of an embodiment of a basic video coding apparatus according to the present invention, including an encoding mode selector.

FIG. 3 is a flowchart of the basic features of an embodiment of a skip mode selection method of the present invention.

FIG. 4 is a graph of the prior art modulation method for skip mode estimation.

FIG. 5 is a graph of the complexity adaptive modulation method of the present invention for skip mode estimation.

FIG. 6 is a flowchart of the basic steps of an embodiment of the complexity adaptive modulation method of the present invention for skip mode estimation.

FIG. 7 is a graph of the complexity adaptive modulation method of the present invention for skip mode estimation, with threshold and modulation level adjustment.

FIG. 8 is a flowchart of the basic steps of an embodiment of a complexity adaptive modulation method of the present invention for skip mode estimation, with threshold and modulation level adjustment.

FIG. 9 is a detailed flowchart of an embodiment of a complexity adaptive modulation method of the present invention for skip mode estimation, with threshold and modulation level adjustment.

FIG. 10 is a block diagram of an embodiment of a complexity adaptive modulation apparatus of the present invention for skip mode estimation, with threshold and modulation level adjustment.

### DETAILED DESCRIPTION OF THE INVENTION

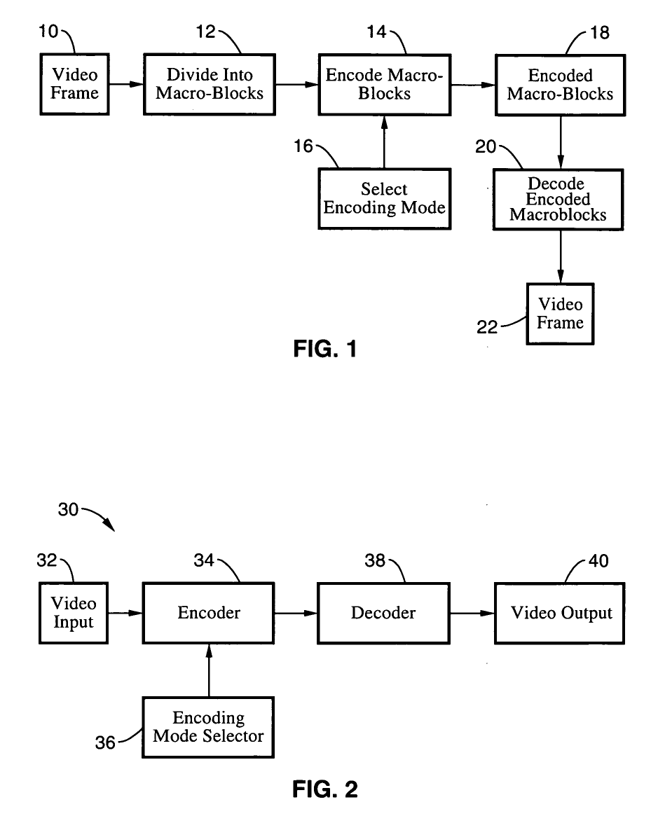

Referring more specifically to the drawings, for illustrative purposes the present invention is embodied in the method and apparatus generally shown in FIG. 1 through FIG. 10. It will be appreciated that the apparatus may vary as to configuration and as to details of the components, and the method may vary as to its particular implementation and as to specific steps and sequence, without departing from the basic concepts as disclosed herein.

The invention pertains to video encoding mode selection within the framework of the AVC standard, but is also applicable in any video encoding system that uses block based encoding. FIGS. 1 and 2 illustrate generally a method and apparatus for coding video data, which can utilize the present invention for encoding mode selection.

In FIG. 1, a video frame 10 is divided into macroblocks, step 12. The macroblocks are encoded (compressed), step 14. The encoding step 14 is performed using an encoding mode that was selected in step 16. The goal of the encoding mode selection step 16 is to select the best mode for encoding each macroblock of a video frame. The encoding step 14 produces encoded (compressed) macroblocks 18, which can be transmitted or stored more easily than the original macroblocks. The encoded macroblocks 18 are then decoded (decompressed), step 20, and used to produce a video frame 22, which optimally will closely match the initial video frame 10.

In FIG. 2, a video input 32 (e.g., a sequence of video frames) is input to encoder (or compressor) 34 of coding system (coder/decoder or codec) 30. Encoder 34 divides each video frame into macroblocks and encodes each macroblock. Encoder 34 has an associated encoding mode selector 36, which selects the encoding mode that encoder 34 uses for each macroblock of a video frame. Encoder 34 produces encoded (compressed) macroblocks, which can be more easily transmitted and stored. The encoded macroblocks are input into decoder 38 which decodes (decompresses) them to produce video output 40, which optimally will closely match initial input video 32.

The basic steps of video coding and the basic structures of coding systems are well known in the art, and can be implemented in many different embodiments and configurations, so they are shown in general functional representations in FIGS. 1 and 2. The invention does not depend on a particular software implementation, steps or sequence, or on a particular embodiment or physical implementation, configuration or embodiment thereof. For example, encoder 34 and decoder 38 are generally processors (e.g. digital computers) programmed with instructions to perform their functions, and may be separate units or may be combined into a single machine.

The present invention applies to the methods of selecting the encoding mode of step 16, and to the encoding mode selector 36, and in particular to skip mode selection. The invention can be implemented in any AVC standard video coding method and apparatus.

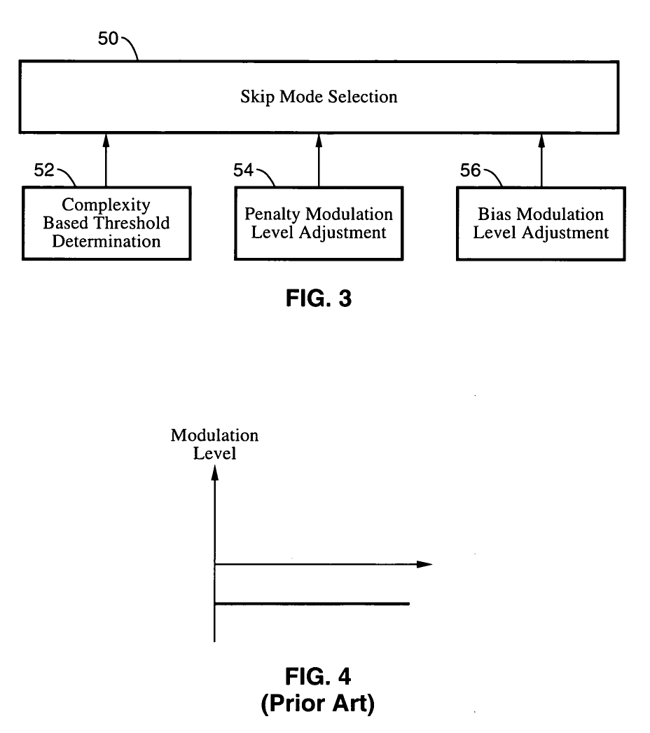

In the present invention, the approach is totally different from the prior art. Instead of fixed bias deduction, both penalty and bias become possible and are adaptively determined according to the real coding condition. The method is illustrated generally in FIG. 3. Skip mode selection 50 can utilize complexity based threshold determination 52, penalty modulation level adjustment 54, and bias modulation level adjustment 56. In the simplest cases, only a threshold with penalty or bias may be needed; in more complex cases threshold, penalty and bias may be adaptively adjusted. Once the skip mode cost is estimated using the invention, it is compared to conventionally obtained inter mode and intra mode costs to select the final mode.

A more detailed description of this embodiment of the invention follows. First, the basic principles related to multi-pass encoding based rate-distortion optimization and SAD/SATD based mode decision for video compression within the AVC standard are presented (Section I). The encoding method of the present invention for skip mode cost modulation is then set forth in detail (Sections IIA, B, C). Finally, a set of experimental results (Section II) and conclusions (Section IV) are provided.

I. AVC Encoding Mode Decision Overview

The selection of the best encoding mode to encode each macroblock is one of the decisions in the AVC standard that has a very direct impact on the bit rate R of the compressed bitstream, as well as on the distortion D in the decoded video sequence. The goal of encoding mode selection is to select the encoding mode that minimizes the distortion subject to a bit rate constraint. To obtain the optimal result, the macroblock mode decision is made by minimizing the Lagrangian functional:

J(s,c,MODE|QP, λ_{MODE})=SSD(s,c,MODE|QP)+λ_{MODE}·R(s,c,MODE|QP)

where QP is the macroblock quantiser, λ_{MODE} is the Lagrange multiplier for mode decision, and MODE indicates a mode chosen from the set of potential prediction modes:

$$\begin{matrix}I frame \text{:} & MODE ∈ \{ INTRA 4 \times 4 , INTRA 16 \times 16 \} , \\ P frame \text{:} & MODE ∈ \{ \begin{matrix}INTRA 4 \times 4 , INTRA 16 \times 16 , SKIP , \\ 16 \times 16 , 16 \times 8 , 8 \times 16 , 8 \times 8\end{matrix} \} \\ B frame \text{:} & MODE ∈ \{ \begin{matrix}INTRA 4 \times 4 , INTRA 16 \times 16 , DIRECT , \\ 16 \times 16 , 16 \times 8 , 8 \times 16 , 8 \times 8\end{matrix} \}\end{matrix}$$

where 8×8 includes all the mode combinations of 8×8, 8×4, 4×8 and 4×4, and INTRA 8×8 MODE is included in FRExtension. The SKIP mode refers to the 16×16 mode where no motion and residual information is encoded. SSD is the sum of the squared differences between the original block s and its reconstruction c given as

$$SSD ( s , c , MODE \vert QP ) = {\sum }_{x = 1 , y = 1}^{16 , 16} {( {s}_{Y} [ x , y ] - {c}_{Y} [ x , y , MODE \vert QP ] )}^{2} + {\sum }_{x = 1 , y = 1}^{8 , 8} {( {s}_{U} [ x , y ] - {c}_{U} [ x , y , MODE \vert QP ] )}^{2} + {\sum }_{x = 1 , y = 1}^{8 , 8} {( {s}_{V} [ x , y ] - {c}_{V} [ x , y , MODE \vert QP ] )}^{2} ,$$

and R(s,c,MODE|QP) is the number of bits associated with choosing MODE and QP, including the bits for the macroblock header, the motion, and all DCT (discrete cosine transformation) blocks. chd Y[x, y, MODE|QP] and s_{Y}[x, y] represent the reconstructed and original luminance values; cᵤ, cᵥ, and sᵤ, sᵥ the corresponding chrominance values.

The Lagrangian multiplier λ_{MODE} is given by

λ_{MODE,P}=0.85×2^{QP/3}

for I and P frames and

$${λ}_{MODE , B} = max ( 2 , min ( 4 , \frac{QP}{6} ) ) \times {λ}_{MODE , P}$$

for B frames, where QP is the macroblock quantization parameter.

The above approach can provide near optimal performance. However, it needs multi-pass encoding and decoding. The related huge complexity prevents its utilization in any practical applications. To solve this problem, the low complexity approach is widely adopted. This low complexity approach can be described by minimizing the following cost functional

J(s,c,MODE|QP,λ_{MODE})=SA(T)D(s,c,MODE|QP)+λ_{MODE}R(MV,REF)

Compared to above, SSD is replaced by SAD or SATD (SA(T)D in the equation stands for either SAD or SATD), the rate only represents the bits to code the motion vector and reference picture index. SAD is the sum of the absolute differences between the original block s and its reconstruction c, and SATD is the sum of the absolute transformed differences between the original block s and its reconstruction c. Note that the cost estimation based on SATD is usually more accurate than SAD, but the complexity of SATD is higher than SAD. Therefore, use of SAD or SATD may depend on the application requirements.

In this way, a one-pass mode decision can be obtained without encoding and decoding process. Since there is no motion vector information for SKIP and INTRA mode, some adjustments are made. For INTRA 16×16 mode, its Lagrangian cost is just SA(T)D; for SKIP mode, 8·f (QP) is subtracted from SA(T)D to favor the skip mode, where f denotes a fixed equation; for the whole intra 4×4 macroblock, 12·f (QP) is added to the SA(T)D before comparison with the best SA(T)D for inter prediction. This is an empirical value to prevent using too many intra blocks. These strategies have been proved to improve the encoding performance.

According to the above analysis, the method to modulate the cost of the skip mode is fixed. Once the quantization scale is fixed, a fixed level will be deducted from the original skip mode cost no matter what is the real condition. This is illustrated in FIG. 4, where the graph shows a fixed bias being deducted. If the cost of the motion vector is not considered, the best inter mode will always obtain the same or better prediction than skip mode. That means current macroblocks that use skip mode will always have quality degradation compared to the best inter mode. Under the condition that quantization error of coding the residue is small, the quality degradation is even bigger. To justify the skip mode, the saved bits by using skip mode need to generate more quality gain when it is applied to other macroblocks. Obviously, the above strategy cannot guarantee it.

IIA. Complexity based skip mode cost modulation

According to the above analysis, the skip mode decision is actually equivalent to bit allocation. Skip mode can save bits at the expense of quality degradation. The problem is how to suitably select it. Based on the conventional R/D theory, if the R/D relationship is exponential-like, the optimal bit allocation will minimize the quality difference of each macroblock within a frame or a set of frames. In this way, if the current macroblock is potentially to have big coding distortion, more bits need to be assigned to it to reduce the distortion. On the other hand, if the current macroblock is potentially to have small coding distortion, no more bits need to be assigned to it to further reduce the distortion. When the average distortion can be obtained, bit allocation can be applied accordingly. Therefore, if the expected distortion of the skip mode is larger than the expected average distortion, it should not be selected. On the other hand, if the expected distortion of the skip mode is less than the expected average distortion, more bias should be given to it such that the saved bits can be used for other macroblocks to obtain the smaller distortion. Since the original skip mode estimation methods use uniform cost deduction without considering the actual distortion, modification is needed to improve the R/D performance.

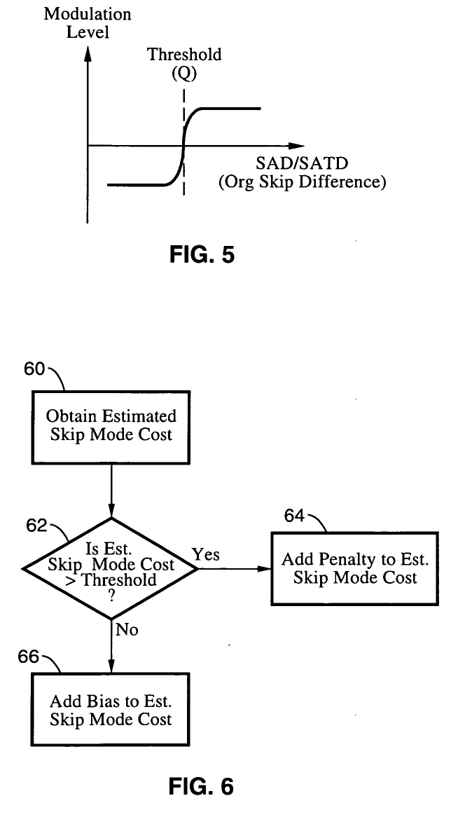

Therefore, the present invention performs skip mode estimation as shown in FIGS. 5 and 6. Instead of using a fixed uniform cost modulation, complexity adaptive modulation is utilized. Here, complexity means the expected distortion of the skip mode. If the complexity is higher than a threshold, modulation will add a penalty to the estimated skip mode cost such that it is less likely to be selected; if the complexity is less than a threshold, modulation will reduce the estimated skip mode cost such that it is more likely to be selected. In FIG. 5, the graph shows a bias being deducted below a threshold Q and a penalty being added above the threshold. As shown in FIG. 6, an initial estimated skip mode cost is first obtained, step 60. This estimated cost is compared to a threshold, step 62. If the estimated cost is greater than the threshold, a penalty is added to the cost, step 64. If the estimated cost is less than the threshold, a bias is subtracted (or negative bias added) to reduce the cost, step 66.

In the R/D theory, distortion is usually calculated by mean square error (MSE or SSD). Assuming the current picture uses the same quantization scale Q, the expected distortion of the current picture after decoding can be roughly estimated as Q²/12 for uniform distribution. Then, this can be set as a threshold and compared with the MSE of the skip mode. However, SAD/SATD are more widely utilized for cost estimation due to their low complexity and good performance. Hence, it is necessary to find a simple way to estimate the SAD/SATD based distortion of the current frame.

The distortion due to quantization can be estimated according to the PDF (probability distribution function) assumption of the DCT residues. Assuming a uniform quantizer with step size Q, the quantization caused SAD/SATD based distortion is given by

$$D ( Q ) = {\sum }_{i = - ∞}^{∞} {\int }_{( i - \frac{1}{2} ) Q}^{( i + \frac{1}{2} ) Q} \vert x - iQ \vert f ( x ) d x$$

It can be shown that this infinite sum converges and is bounded by Q. Since there are 256 pixels in one macroblock, the SAD/SATD of one macroblock is bounded by 256 Q. Recent research shows that the Cauchy distribution more accurately reflects the distribution of AVC coded DCT residues. Thus, it can be used to obtain the expected distortion based on the above equation. In reality, rate control may use different Q's for different macroblocks. In this case, picture level QP should be used to obtain the expected distortion. After that, the expected distortion is used as the threshold. If the current skip mode caused SAD/SATD to be larger than the threshold, the penalty is gradually added to the skip mode cost; if the current skip mode caused SAD/SATD to be less than the threshold, the cost of the skip mode is gradually reduced by subtracting the bias. After this modulation, the skip mode cost is compared to the best inter mode cost and best intra mode cost to determine the final mode.

IIB. Complexity Based Threshold and Modulation Level Adjustment

In the current video encoding strategy, the accuracy of motion estimation is partly dependent on the quality of the previous reference frame.

If the previous frame has good quality, the prediction residue will be less in the next frame and the same quality can be obtained by using fewer bits; if the previous frame has bad quality, the prediction residue will be more in the next frame and the same quality can only be obtained by using more bits. Although skip mode can save many bits, the quality of the macroblock (MB) using skip mode is usually worse than using other inter modes. In low bit-rate conditions, the quality of the reference picture is usually not very good due to the big quantization scale. Hence, even with very good motion estimation, there are still many residues left after compensation. Under this condition, the percentage of skip mode by using the conventional method is higher. That means the bad quality in the previous frame more frequently transmits to the subsequent frames. Under this condition, it is necessary to add more penalties to the skip mode in the low bit rate. On the contrary, more bias should be given to the skip mode in the high bit rate.

For a low complexity application such as a mobile device, SAD has to be used to save the encoding time. Since SAD is done in spatial domain, sometimes it is not accurate compared to SATD. Through our investigation, we found that a smaller threshold should be used when SAD based prediction is used.

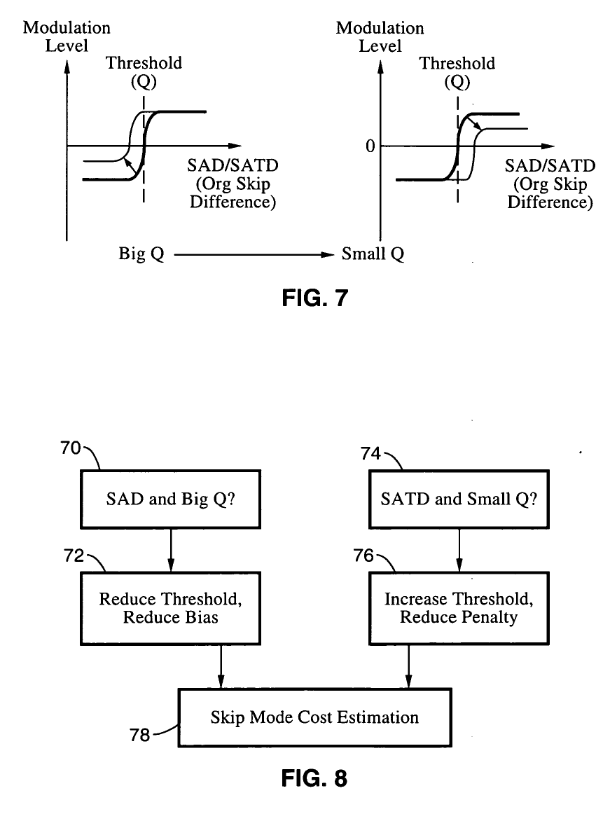

With the above analysis in mind, the present invention can be further adjusted as follows, as illustrated in FIGS. 7 and 8. As shown in the graph of FIG. 7, when SAD is used and big quantization (e.g., greater than a particular value) is adopted, the threshold is moved to the left (reduction) and the bias to the skip mode is reduced. When SATD is used and small quantization (i.e. less than a particular value) is adopted, the threshold is moved to the right (increase) and the penalty to the skip mode is reduced. FIG. 8 illustrates the steps of the process. In step 70, it is determined whether SAD and big Q are used. If yes, then the threshold and bias are both reduced, step 72. In step 74 it is determined if SATD and small Q are used. If yes, then the threshold is increased and the penalty is reduced, step 76. Either step 72 or 76 results in an adjustment to the skip mode cost estimation, step 78. If neither step 70 nor step 74 is true, then no adjustments are made and the method as shown in FIGS. 5 and 6 is used.

IIC. Overall Scheme for Skip Mode Cost Estimation

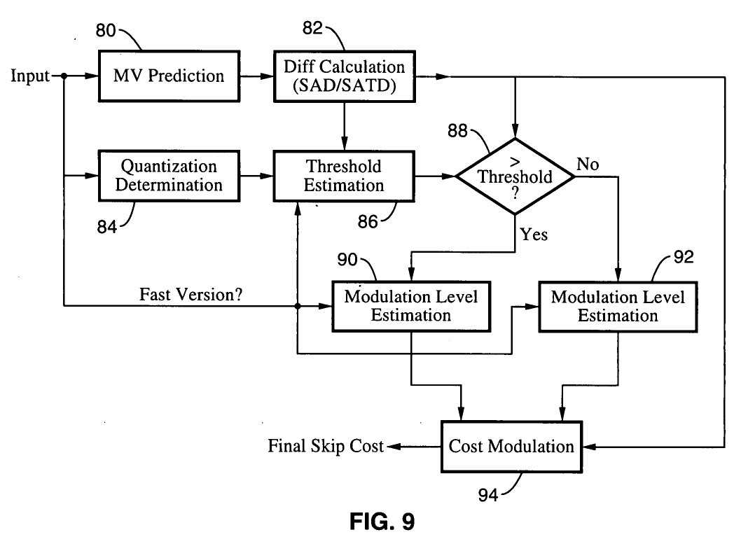

The overall skip mode estimation scheme of the invention is shown in FIG. 9. First, in step 80, the predicted motion vector is obtained from the neighbor macroblocks. Based on this motion vector, the difference between the current macroblock and the predicted macroblock in the previous picture is calculated, step 82. The SAD or SATD is obtained accordingly. At the same time, in step 84, quantization scale is derived from the rate control module (not shown). The initial threshold is calculated, step 86. If SAD or very fast codec is used, the threshold is adjusted according to the above procedure. Then, the skip mode SAD/SATD is compared with the threshold, step 88. If it is greater than the threshold, the penalty modulation level is calculated based on the quantization level (and any adjustments to threshold), step 90; if it is less than the threshold, the bias modulation level is calculated based on the quantization level (and any adjustments to threshold), step 92.

Finally, the skip mode cost is modulated by either penalty level or bias level, step 94.

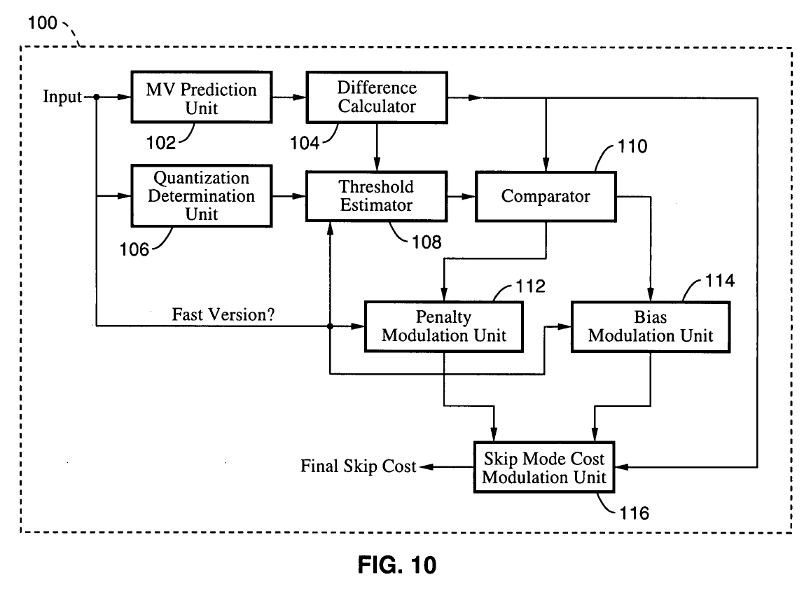

An apparatus 100 for carrying out the overall skip mode estimation scheme of FIG. 9 is shown in FIG. 10. MV prediction unit 102 obtains the predicted motion vector from the neighbor macroblocks. Based on this motion vector, the difference between the current macroblock and the predicted macroblock in the previous picture is calculated in difference calculator 104.

The SAD or SATD is obtained accordingly. At the same time, quantization determination unit 106 derives the quantization scale from the rate control module (not shown). The initial threshold is calculated by threshold estimator 108, using inputs from difference calculator 104 and quantization determination unit 106. If SAD or very fast codec is used, the threshold is adjusted according to the above procedure. Then, the skip mode SAD/SATD from difference calculator 104 is compared with the threshold from threshold estimator 108 in comparator 110. If it is greater than the threshold, the penalty modulation level is calculated in penalty modulation unit 112 based on the quantization level (and any adjustments to threshold); if it is less than the threshold, the bias modulation level is calculated in the bias modulation unit 114 based on the quantization level (and any adjustments to threshold). Finally, the skip mode cost is modulated by either penalty level or bias level in the skip mode modulation unit 116. Apparatus 100 is generally a processor, e.g. digital computer, or a part thereof, and the various components may be implemented in hardware or in software.

Thus the invention provides improved method and apparatus of the types shown generally in FIGS. 1 and 2 for coding video data. The improvement provided by the invention lies in the step 16 of selecting the encoding mode and the encoding mode selector 36. The remainder of the method and apparatus are conventional and therefore not described in further detail. The invention is carried out in a processor, e.g. digital computer, and includes a machine readable medium or program storage device containing program instructions, which when executed by the machine, cause the machine to perform the method of the invention.

III. Experimental Results

The effectiveness of the skip mode optimization method of the present invention has been tested. Two sequences have been tested. Flower is an interlaced sequence and is coded by an IP only structure with two reference fields (I frames); City is a progressive sequence and is coded by an IP only structure with one reference frame. In order to obtain fair comparison, the performance was first tested by using fixed QP with fast coding (SAD, fast inter mode decision in SONY Real Time AVC Encoder). The results are shown in Table 1 below. It is seen that the present method significantly improves the performance of the fast encoder by using fixed QP.

Then, the performance was tested by using rate control when high quality coding (SATD, SONY High Quality AVC Encoder) is used. The results are shown in Table 2 below. It is seen that the present method also improves the performance of the high quality encoder when rate control is used.

Besides the SONY codec, the invention has also been tested on other codecs. Moderate coding gain has been obtained.

IV. Conclusions

This invention provides a method and apparatus to improve the skip mode selection in P pictures within the framework of the AVC standard.

Radically different from the prior art, which uses fixed bias to favor the skip mode, the invention has improved skip mode estimation by complexity based threshold determination, penalty modulation level adjustment and bias modulation level adjustment for the encoding mode selection. Experimental results have demonstrated the superior subjective and objective quality of the invention on various video sequences compared to the result obtained using a reference encoder. In the case of fast low complexity encoding, the improvement is significant. Moreover, this improvement is obtained without any complexity increase and can be easily embedded into any encoding system. Although the present invention makes use of the AVC framework, the encoding method of the present invention is applicable in any video encoding system that employs the block based encoding design.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

TABLE 1

| IPP | | | | | | |
|---|---|---|---|---|---|---|
| only | | | | | | |
| QP | Sony_Fast | Skip Opt | % | Sony_Fast | Skip Opt | diff |
| | Bit-rate(flower) | | | PSNR(flower) | | |
| 29 | 4,077,527 | 3,943,707 | −3.3 | 33.00 | 33.04 | +0.04 |
| 32 | 2,777,976 | 2,667,699 | −4.0 | 30.52 | 30.58 | +0.06 |
| 35 | 1,748,586 | 1,654,423 | −5.2 | 28.05 | 28.13 | +0.06 |
| | Bit-rate(city) | | | PSNR(city) | | |
| 29 | 2,659,774 | 2,477,166 | −6.8 | 34.55 | 34.61 | +0.06 |
| 32 | 1,479,519 | 1,358,861 | −8.1 | 32.54 | 32.64 | +0.10 |
| 35 | 877,908 | 814,572 | −7.2 | 30.68 | 30.83 | +0.15 |

TABLE 2

| IPP only | | | | | | |
|---|---|---|---|---|---|---|
| Rate | | | | | | |
| setting | Sony_HQ | Skip Opt | % | Sony_HQ | Skip Opt | diff |
| | Bit-rate(flower) | | | PSNR(flower) | | |
| 1M | 639,789 | 639,059 | −0.1 | 24.00 | 24.15 | +0.15 |
| 2M | 1,237,533 | 1,232,213 | −0.4 | 26.86 | 26.98 | +0.12 |
| 4M | 2,454,048 | 2,444,646 | −0.4 | 30.27 | 30.34 | +0.07 |
| | Bit-rate(city) | | | PSNR(city) | | |
| 1M | 1,829,796 | 1,822,735 | −0.4 | 33.33 | 33.43 | +0.10 |
| 2M | 3,650,986 | 3,644,997 | −0.2 | 35.52 | 35.57 | +0.05 |
| 4M | 7,423,811 | 7,422,716 | −0.0 | 37.49 | 37.52 | +0.03 |

What is claimed is:

1. A method for estimating skip mode cost in the coding of a macroblock in a video frame, comprising:
determining an initial skip mode cost; and
modulating the initial skip mode cost based on complexity or expected distortion of the skip mode.

2. A method as recited in claim 1, wherein modulating the initial skip mode cost comprises:
determining a threshold;
comparing the initial skip mode cost to the threshold;
adding a penalty to the initial skip mode cost if the initial skip mode cost is greater than the threshold; and
deducting a bias from the initial skip mode cost if the initial skip mode cost is less than the threshold.

3. A method as recited in claim 2, further comprising:
adjusting the threshold; and
modulating the level of the penalty or bias.

4. A method as recited in claim 2, further comprising determining the initial skip mode cost by obtaining a predicted motion vector from neighbor macroblocks and calculating the SAD or SATD between a current macroblock and a predicted macroblock.

5. A method as recited in claim 4, further comprising determining the threshold by deriving a quantization scale and estimating the threshold from the quantization scale.

6. A method as recited in claim 5, further comprising:
reducing the threshold and bias if SAD and a large quantization is used; and
increasing the threshold and reducing the penalty if SATD and small quantization are used.

7. A method as recited in claim 1, further comprising:
comparing an estimated skip mode cost to an inter mode cost and an intra mode cost to select the lowest cost; and
selecting a coding mode for coding a macroblock in a video frame based on said comparison.

8. A method as recited in claim 7, further comprising:
dividing the video frame into macroblocks; and
coding each macroblock using the selected coding mode.

9. A method as recited in claim 6, further comprising:
comparing an estimated skip mode cost to an inter mode cost and an intra mode cost to select the lowest cost; and
selecting a coding mode for coding a macroblock in a video frame based on said comparison.

10. A method as recited in claim 9, further comprising:
dividing the video frame into macroblocks;
coding each macroblock using the selected mode.

11. An apparatus for estimating skip mode cost in the coding of a macroblock in a video frame, comprising:
a motion vector prediction unit; and
a difference calculator connected to the motion vector prediction unit for calculating the SAD or SATD between a current macroblock and a predicted macroblock to provide an initial skip mode cost.

12. An apparatus as recited in claim 11, further comprising:
a quantization determination unit;
a threshold estimator connected to the quantization determination unit and the difference calculator to provide a threshold;
a comparator connected to the difference calculator and threshold estimator to compare the initial skip mode cost to the threshold;
a penalty modulation unit connected to the comparator to add a penalty if the initial skip mode cost is greater than the threshold;
a bias modulation unit connected to the comparator to deduct a bias if the initial skip mode cost is less than the threshold; and
a skip mode cost modulation unit connected to the penalty and bias modulation units to provide a final skip mode cost.

13. An apparatus as recited in claim 12, wherein the threshold estimator, penalty modulation unit, and bias modulation unit adjust the threshold, penalty and bias, respectively, depending on whether the difference calculator calculates SAD or SATD and the quantization scale.

14. An apparatus for estimating skip mode cost in the coding of a macroblock in a video frame, comprising:
means for determining an initial skip mode cost; and
means for modulating the initial skip mode cost based on complexity or expected distortion of the skip mode.

15. An apparatus as recited in claim 14, wherein said means for modulating the initial skip mode cost comprises:
means for determining a threshold;
means for comparing the initial skip mode cost to the threshold;
means for adding a penalty to the initial skip mode cost if the initial skip mode cost is greater than the threshold; and
means for deducting a bias from the initial skip mode cost if the initial skip mode cost is less than the threshold.

16. An apparatus as recited in claim 15, further comprising:
means for adjusting the threshold; and
means for modulating the level of the penalty or bias.

17. An apparatus as recited in claim 15, further comprising means for determining the initial skip mode cost by obtaining a predicted motion vector from neighbor macroblocks and calculating the SAD or SATD between a current macroblock and a predicted macroblock.

18. An apparatus as recited in claim 17, further comprising means for determining the threshold by deriving a quantization scale and estimating the threshold from the quantization scale.

19. An apparatus as recited in claim 18, further comprising:
means for reducing the threshold and bias if SAD and a large quantization is used; and
means for increasing the threshold and reducing the penalty if SATD and small quantization are used.

20. An apparatus as recited in claim 14, further comprising:
means for comparing an estimated skip mode cost to an inter mode cost and an intra mode cost to select the lowest cost; and
means for selecting a coding mode for coding a macroblock in a video frame based on said comparison.
